(19) United States
(12) Patent Application Publication
(10) Pub. No.: US 2001/0051913 A1
(43) Pub. Date: Dec. 13, 2001

(54) Method and system for outsourcing information technology projects and services

(76) Inventors: Avinash Vashistha, Bangalore (IN); Atul Vashistha, Pleasanton, CA (US)

Correspondence Address: R. Lee Fraley, Snell & Wilmer, One Arizona Center, 400 E. Van Buren, Phoenix, AZ, 85004-2202, US

(21) Appl. No.: 09/878,025

(22) Filed: Jun. 7, 2001

Related U.S. Application Data
(60) Provisional application No. 60/210,117, filed on Jun. 7, 2000.

(51) Int. Cl. G06F 17/60

(52) U.S. Cl. 705/37

(57) ABSTRACT

A method and system for facilitating the outsourcing of information technology of projects and services is provided. The method and system can be implemented to enable buyers and IT providers to confer and agree in a very efficient, neutral and intelligent manner. The information technology projects and services can range from the simple and not urgent, to the complex and time critical. An exemplary outsourcing method and system can comprise a start module, a registration module, a request for proposal (RFP) module, a matching module, a bidding and discussion module, and a selection module configured for the planning, outsourcing, and procuring of information technology projects and services. In addition, a system and method for outsourcing IT projects and services can also include a project administration method and system for delivering and/or managing the IT projects and services. In accordance with an exemplary embodiment, the project administration method and system can be configured to enable the buyer and the provider to oversee the delivery of the IT project, such as by using a browser-based application, to provide a secure workspace where project teams can suitably collaborate, conduct online conversations, track project milestones, monitor service levels, resolve issues, solicit feedback and/or authorize payment. Further, the method and system can be accomplished by providing automated processes and systems, through online and/or packaged software, implemented at the host and client systems. The automated processes and systems can comprise extensive knowledge base, rule-based and state of the art database driven, self-learning business logic based on an end-to-end IT outsourcing process. In addition, security features can be suitably implemented to provide protection to the to data and information for buyers and prospective providers.

### CROSS-REFERENCE TO RELATED APPLICATIONS

This application claims priority from prior pending U.S. Provisional Application No. 60/210,117, entitled “Method and System for Outsourcing Information Technology”, and filed Jun. 7, 2000.

### FIELD OF INVENTION

The present invention relates to an information technology (IT) outsourcing methodology. More particularly, the present invention relates to a method and system configured for facilitating the outsourcing of information technology projects and services, including the planning, outsourcing, procuring, managing and/or delivering of the information technology projects and services.

### BACKGROUND OF THE INVENTION

Technology advancement is an integral part of any company's product development strategy. Technology leaders in companies ranging from e-startups to the Global 2000 continuously struggle with pressures to deliver affordable, quality technology solutions for their organizations. Unfortunately, from the design stage to the end product, these technology leaders are also faced with other pressures, including, for example, project costs, the time to market, the varying levels of expertise with team members, as well as a shortage of skilled, qualified IT professionals. Moreover, these technology leaders must choose between several technology strategies to deliver a final product, such as staff augmentation, traditional project outsourcing, or e-Procurement strategies.

When considering these three strategies among others, companies often choose to complete the high-technology development internally, for example, by hiring permanent or temporary employees to form the technology team. Most often, the team members are located within the same physical location or building. Once the team members are in place, companies typically assign a design group, an integration team and a project manager to each project. The design group is generally given the specifications of the product and are held responsible for the design, coding, integration, testing and acceptance of the product. The integration team is generally responsible for completing the project management and tracking records. Finally, the project manager generally oversees the entire process. Most companies deem the key advantage of the staff augmentation strategy to be that the project is completed within close proximity to the organization, keeping the companies more in control of the process.

While many companies prefer to keep their high-technology, mission-critical projects in-house, several market developments have made outsourcing to external IT provider companies, i.e., IT Providers, very appealing. Because of a shortage of information technology resources, e.g., the limited availability and high-level knowledge of technology professionals, combined with the pressure to meet time-to-market and cost effectiveness demands, companies have ventured into procuring larger outsourcing contracts for high-technology projects with information technology provider companies. These outsider provider companies are sometimes “re-located” within an organization, but often perform the work offsite from the host company, including the performing of the work offshore.

The most popular outsourcing countries continue to include the U.S., UK, India, Ireland, Israel, Russia, Vietnam and the Philippines. However, despite the large number of available IT provider companies, the ability to identify and locate quality IT provider companies is limited. The current outsourcing process is plagued with several problems, including inefficiencies in developing project specifications, as well as difficulties in identifying potential companies to outsource projects, such as searching costs, tapping global resources, verifying qualifications of providers, and selecting the best IT provider company. More specifically, there are currently few online marketplaces and/or technology solutions that make available to companies seeking IT services, i.e., buyers, a system which contains any features for planning, procuring, managing or delivering IT services and projects that, in turn, allows the company to deliver quality products to their customers. Instead, most traditional outsourcing systems only provide a process for providing a request for proposal (RFP) and a process for identifying potential IT providers. Thus, while companies have found traditional outsourcing methods alleviate some of the time-to-market and cost pressures, there remains a tremendous opportunity to improve the outsourcing and procurement of IT projects and services.

It is estimated that Global 2000 companies that outsource IT projects through traditional methods currently spend over $75,000 per project during the RFP process, with up to an additional six months in the sourcing and selecting of an external services provider for each IT services project. The competitive advantage lost by due to such delays in their projects cannot be recovered nor weighted. Additionally, approximately 80 percent of the Fortune 1000 enterprises do not have a formal process for procuring IT services. Accordingly, companies face problems in developing project specifications, selecting qualified provider companies, negotiating terms and conditions for agreements, managing, tracking and administrating projects, measuring productivity, performance and delivery schedule, and verifying product quality. Moreover, most organizations lack the systems that can enable them to streamline IT services outsourcing and establish the methodology and systems necessary to improve sourcing and negotiate better volume discounts with preferred IT service providers.

Accordingly, a need exists for a method and system that addresses the above inefficiencies related to the planning, outsourcing, procuring, managing and/or delivering of information technology projects and services.

### SUMMARY OF THE INVENTION

The method and system according to the present invention addresses many of the shortcomings of the prior art. In accordance with various aspects of the present invention, an exemplary method and system can be configured for facilitating the outsourcing of information technology of projects and services. For example, the exemplary method and system can be configured for the planning, outsourcing, and procuring of information technology projects and services. The method and system can be implemented to enable buyers and IT providers to confer and agree in a very efficient, neutral and intelligent manner. These information technology projects and services can range from the simple and not urgent, to the complex and time critical.

In accordance with an exemplary embodiment, an exemplary outsourcing method and system can comprise a start module, a registration module, a request for proposal (RFP) module, a matching module, a bidding and discussion module, and a selection module configured for the planning, outsourcing, and procuring of information technology projects and services.

In accordance with another aspect of the present invention, a system and method for outsourcing IT projects and services can also include a project administration method and system for delivering and/or managing the IT projects and services. In accordance with an exemplary embodiment, the project administration method and system can be configured to enable the buyer and the provider to oversee the delivery of the IT project, such as by using a browser-based application, to provide a secure workspace where project teams can suitably collaborate, conduct online conversations, track project milestones, monitor service levels, resolve issues, solicit feedback and/or authorize payment.

In accordance with another aspect of the present invention, the method and system can be accomplished by providing automated processes and systems, through online and/or packaged software, implemented at the host and client systems. The automated processes and systems can comprise extensive knowledge base, rule-based and state of the art database driven, self-learning business logic based on an end-to-end IT outsourcing process. In addition, security features can be suitably implemented to provide protection to the to data and information for buyers and prospective providers.

### BRIEF DESCRIPTION OF THE DRAWING

A more complete understanding of the present invention may be derived by referring to the detailed description when considered in connection with the figure, where:

FIG. 1 is a block diagram representation of an exemplary implementation of a method and system for outsourcing information technology in accordance with the present invention;

FIG. 2 is a block diagram representation of another exemplary implementation of a method and system for outsourcing information technology in accordance with the present invention;

FIG. 3 is a block diagram representation of yet another exemplary implementation of a method and system for outsourcing information technology in accordance with the present invention;

FIG. 4 illustrates a block diagram representation of an exemplary method and system for outsourcing information technology projects and services in accordance with the present invention;

FIG. 5 illustrates a block diagram representation of an exemplary method and system for administrating and managing information technology projects and services in accordance with the present invention;

FIG. 6 illustrates an exemplary buyer and provider profile for an exemplary matching process in accordance with the present invention;

FIG. 7 illustrates an exemplary matrix as may be utilized in an exemplary selection process in accordance with the present invention;

FIG. 8 illustrates an exemplary RFP and provider bidding profile as may be utilized in an exemplary selection process in accordance with the present invention;

FIG. 9 illustrates a block diagram representation of another exemplary method and system for outsourcing information technology projects and services in accordance with the present invention;

FIG. 10 illustrates an exemplary registration process in accordance with the present invention;

FIG. 11 illustrates an exemplary request for proposal process in accordance with the present invention;

FIG. 12 illustrates an exemplary communication network for implementation of an outsourcing method and system in accordance with the present invention; and

FIG. 13 illustrates another exemplary communication network for implementation of an outsourcing method and system in accordance with the present invention.

### DETAILED DESCRIPTION OF EXEMPLARY EMBODIMENTS

The present invention may be described herein in terms of various software modules and processing steps. It should be appreciated that such modules and steps may be realized by any number of hardware components configured to perform the specified functions. For example, the present invention may employ various input/output devices, data storage and memory devices, terminals, and the like, which may carry out a variety of functions under the control of one or more microprocessors or other control devices. In addition, those skilled in the art will appreciate that the present invention may be practiced in any number of communication contexts and that the illustrative embodiments as described herein are merely two exemplary applications for the invention. For example, the principles, features and methods discussed may be applied not only through internet access and through packaged software by buyers and providers of information technology, but also through direct telephonic or other like means of personal communication. Further, such general techniques that may be known to those skilled in the art are not described in detail herein.

As discussed above, while the present systems and methodologies for outsourcing IT projects and services may have some capabilities for buyers to request such projects and services and to identify potential IT providers, various deficiencies exist. Notably, the present systems and methodologies fail to provide a sufficient mechanism for project bidding, IT provider selection, and project administration functions, among other features. However, in accordance with various aspects of the present invention, an exemplary method and system can be configured for facilitating the outsourcing of information technology of projects and services. For example, the exemplary method and system can be configured for the planning, outsourcing, procuring, managing and/or delivering of information technology projects and services.

In accordance with one aspect of the present invention, the method and system of the present invention enables buyers, i.e., companies that need IT projects and/or services implemented and completed, to obtain end-to-end knowledge and support to initiate, decide and implement IT projects and services with providers, i.e., world-wide companies suitably qualified and willing to provide outsourced IT projects and services to others. In addition, the method and system can be implemented to enable buyers and IT providers to confer and agree in a very efficient, neutral and intelligent manner for the planning, outsourcing, procuring, managing and/or delivering of information technology projects and services. These information technology projects and services can range from simple and non-urgent types, to very complex and time critical projects and services.

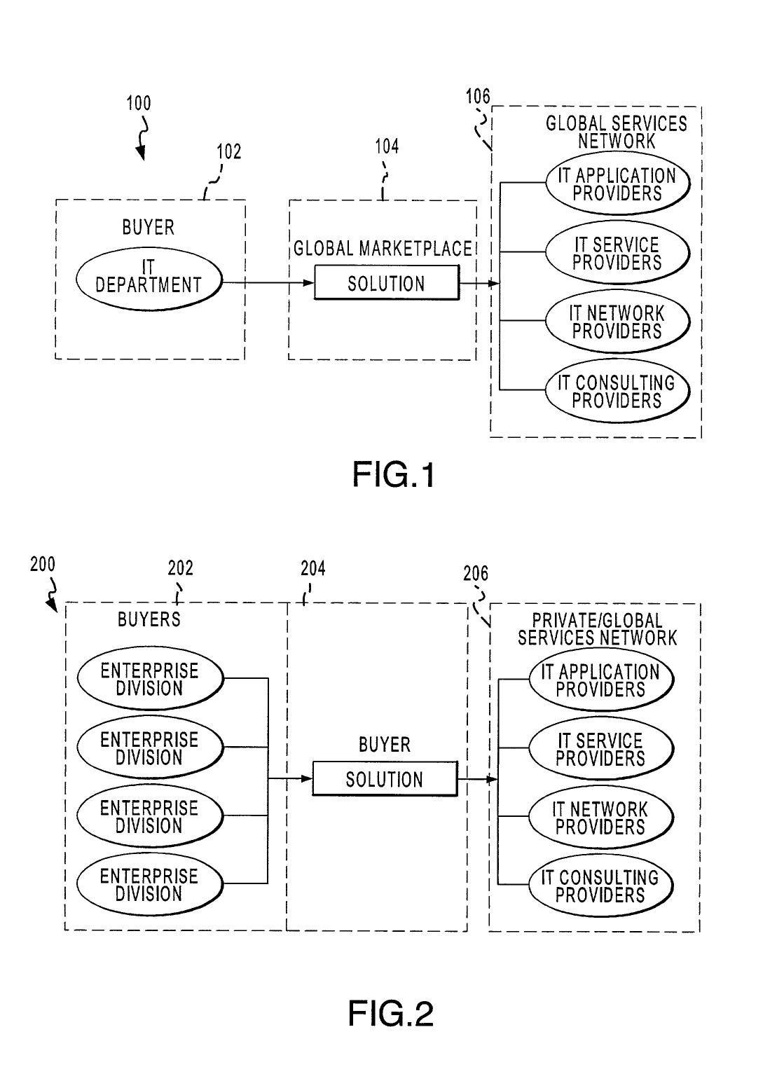

The configurations of buyers and IT providers can comprise various types and arrangements suitable for implementation of the method and systems of the present invention. For example, in accordance with an exemplary embodiment, and with reference to FIGS. 1 through 3, an implementation 100, 200 or 300 of the method and system of the present invention can comprise at least one buyer entity, an outsourcing system, and at least one provider entity.

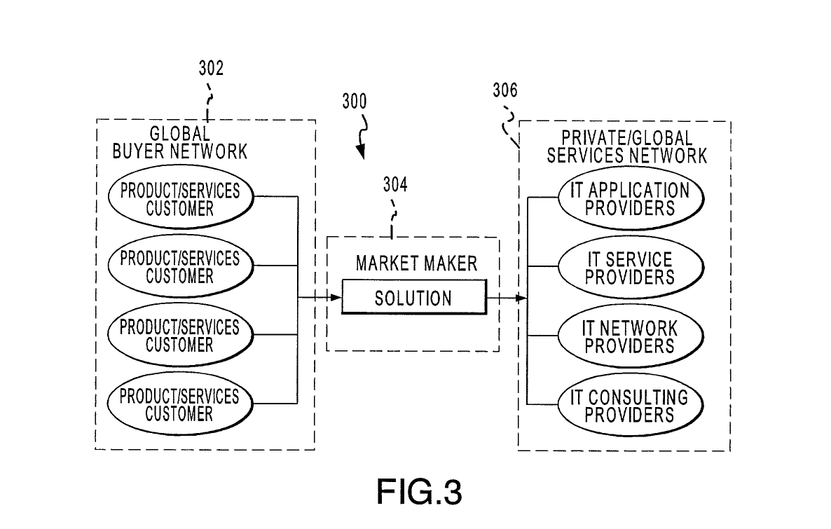

The buyer and provider entities can comprise various forms and configurations for using the outsourcing system and methodologies. For example, with reference to FIG. 1, a buyer entity can comprise an IT department or organization 102 within a company or corporation. As a result, IT department 102 can access providers 106 through utilization of an outsourcing system 104 configured to provide a global marketplace solution such that IT projects and services can be developed and implemented. In addition, with reference to FIG. 2, a buyer entity can comprise one or more enterprises or divisions 202 within a company having a need for IT projects and services. These enterprises or divisions 202 can suitably utilize outsourcing system 204 independently of each other to identify, select and utilize providers 206 as desired, i.e., outsourcing system 204 can provide a buyer solution for coordinating and handling multiple projects of multiple enterprises within a single buyer. Further, with reference to FIG. 3, a buyer entity can comprise a global network 302 of buyers having a need for IT projects and services, with each buyer being capable of independently selecting and utilizing providers 306 through use of an outsourcing system 304 which operates as a market maker solution. Accordingly, a buyer entity comprise any configuration from a single buyer to multiple or networked buyers.

Meanwhile, a provider entity can suitably comprise a single IT provider, or a private or global services network of IT providers, such as networks 106, 206 or 306. In addition, the single IT provider, or any of the providers within networks 106, 206 or 306 can comprise various types of IT providers. For example, the IT providers can comprise application providers for developing and providing IT applications. In addition, the IT providers can comprise service providers for servicing IT systems within the buyer's company. Further, the IT providers can comprise network providers for developing or managing a network system with the buyer's company, or consulting providers for providing general or specific consulting resources to the company.

As will be described in more detail below, to facilitate access by the buyers through the outsourcing systems to the providers, the outsourcing systems and methodologies can be suitably implemented in various manners. For example, the outsourcing systems and methodologies can be suitably implemented through an Internet Protocol (IP) network having a secure marketplace, or through software that can be suitably integrated into the buyer's existing technology systems. Other configurations are possible for implementation as well.

As discussed above, an exemplary method and system for facilitating the outsourcing of IT projects and services can comprise various features, functional modules, components and elements in accordance with various exemplary embodiments of the present invention. For example, an exemplary method and system can be configured for the planning, outsourcing, procuring, managing and/or delivering of information technology projects and services.

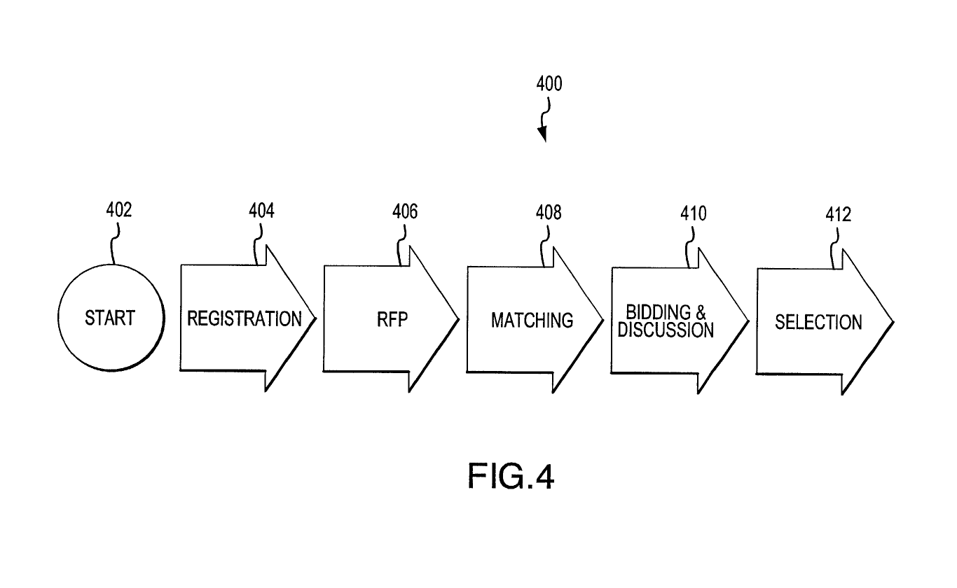

With reference to FIG. 4, an exemplary outsourcing system 400 can comprise a start module 402, a registration module 404, a request for proposal (RFP) module 406, a matching module 408, a bidding and discussion module 410, and a selection module 412. Start module 402 suitably comprising an initialization process for enabling a buyer or provider to interface outsourcing system 400. This initialization process can comprise various forms and steps, such as the accessing of outsourcing system 400 through Internet access, or any other communication network or protocol.

Registration module 402 suitably comprises a mechanism for facilitating the creation of a secure workplace or operation for buyers and providers of IT projects and services, with the workplace containing various levels of buyer and provider information. For example, registration module 402 can comprise functions for capturing and editing the summary and detailed profiles of the various buyers and sellers. These summary and detailed profiles can be suitably captured and edited through a security managing function within or associated with registration module 402 to ensure the security of the data and information collected. In addition, the summary and detailed profiles can comprise the capture of numerous data elements, for example 400 or more data elements, to enable outsourcing system 400 to suitably match potential buyers and providers for outsourcing IT projects and services. These data elements can comprise various forms and categories, such as data comprising general buyer and provider information, data within a providers domain knowledge, expertise and technical skills. In zddition, the buyer and provider profiles can be suitably stored in various databases, such as, for example, a profile register database, or a buyer database and a provide database, or any other profile database.

RFP module 406 suitably comprises a comprehensive request for proposal (RFP) mechanism for permitting a buyer to provide outsourcing system 400 with the particular IT service or solution needs, requirements and/or specifications for an IT project or service. In accordance with an exemplary embodiment, RFP module 406 comprises a customizable, intelligent, template driven technology configured for incorporation of numerous outsourcing elements for suitably identifying an IT project or service requested by the buyer. In addition, the template technology can be configured to be context sensitive, so that the template forms can change based on the buyer's industry and domain responses. Further, the categories of the outsourcing elements captured within RFP module 406 can include various types, such as domain knowledge, technical skill sets, development platforms, experience base, quality certifications, and the budget and time to market. Additionally, RFP module 406 can be configured to provide the ability for the buyer to attach additional documents and materials that might be necessary for a provider to submit a bid. Moreover, RFP module 406 can be adaptable to be utilized as a request for information (RFI) tool to enhance the outsourcing process for buyers wishing to incorporate RFP module 406 as a preliminary outsourcing step.

Matching module 408 suitably comprises an intelligent search and matching engine configured for analyzing data and criteria obtained from buyers within RFP module 406 to suitably match providers based on the data elements captured from the providers during registration module 404. Through the matching process, matching module 408 can be configured to identify and alert only qualified providers of the opportunity to bid, i.e., only those providers meeting a minimum level of matching between data and criteria of buyers and data elements defining the qualifications of providers. In addition, matching module 408 can be configured to provide the buyer with the option to match the RFI/RFP criteria only with providers the buyer currently utilizes, to match within a global network of IT providers, or match with both groups of providers. Matching module 408 can also be suitably configured to notify each qualified provider through various mechanisms, such as through via e-mail messages through an IP or other network, or other manners of written correspondence, providing the buyers with the buyer's RFI/RFP for IT projects and/or services, a template driven bid form, the bid deadline and the ability to upload supporting documentation. In addition, the buyer can also be notified through similar mechanisms to identify the number of qualified provider matches found.

Bidding and discussion module 410 suitably comprises a mechanism for facilitating the collaboration between buyers and providers to obtain an improved understanding of the RFP and desired IT project and services to facilitate an effective bidding process. For example, to allow providers to collaborate with buyers for better communication and understanding of the RFP requirements, module 410 can provide secure channels of communication between a buyer and a single provider or a group of providers. In addition, all modes of communications, e.g., whether asynchronous or synchronous, can be suitably monitored by module 410, with transcripts made available according to preset user rights.

For the bidding functions, module 410 can suitably provide bid templates to the selected providers in their private, secure workspace. The bid templates can be configured to be unique based on the type of RFI/RFP inquiry submitted by the Buyer. Each provider selected to bid on a project can be provided a deadline for submittal that is determined by the buyer. After the bid deadline has passed, an automatic notification can be submitted to the buyer and all selected providers. The notification can be suitably submitted to providers to indicate that the bids will be made available to the buyer and suitably scored, ranked and short-listed and/or selected during the process of selection module 412. In addition, providers that did not submit a bid can also be encouraged to bid on future projects of the buyer or other buyers.

Selection module 412 suitably comprises an intelligent bid selection engine configured to score and rank the provider bids based on buyer specified selection criteria. For example, selection module 412 can be configured to suitably score, rank, and provide results to buyers in a readily comparable format, for example a matrix format, along with complete bid documents from the providers. In addition, the ranking provided by selection module 412 can suitably takes into consideration levels of importance and weights specified by the buyer for the data and criteria submitted in RFP module 406 with the responses submitted by the providers to create a selection matrix that enables a buyer to compare the bids in a one-to-one fashion.

As a result of the above modules, elements and components, outsourcing system 400 can be implemented to enable buyers and IT providers to confer and agree in a very efficient, neutral and intelligent manner for the planning, outsourcing, and/or procuring of information technology projects and services. However, it should be noted that while the systems and methodologies include a process for suitably selecting and matching buyers of information technology with appropriate providers, various of the above steps, functions and features may be suitably modified or deleted, and/or arranged in various manners, and that the above description is merely for illustrative purposes. For example, while start module 402 and registration module 404 are illustrated as separate modules, the features and functions can be suitably incorporated into or otherwise combined within registration module 404 in accordance with various other exemplary embodiments of the present invention.

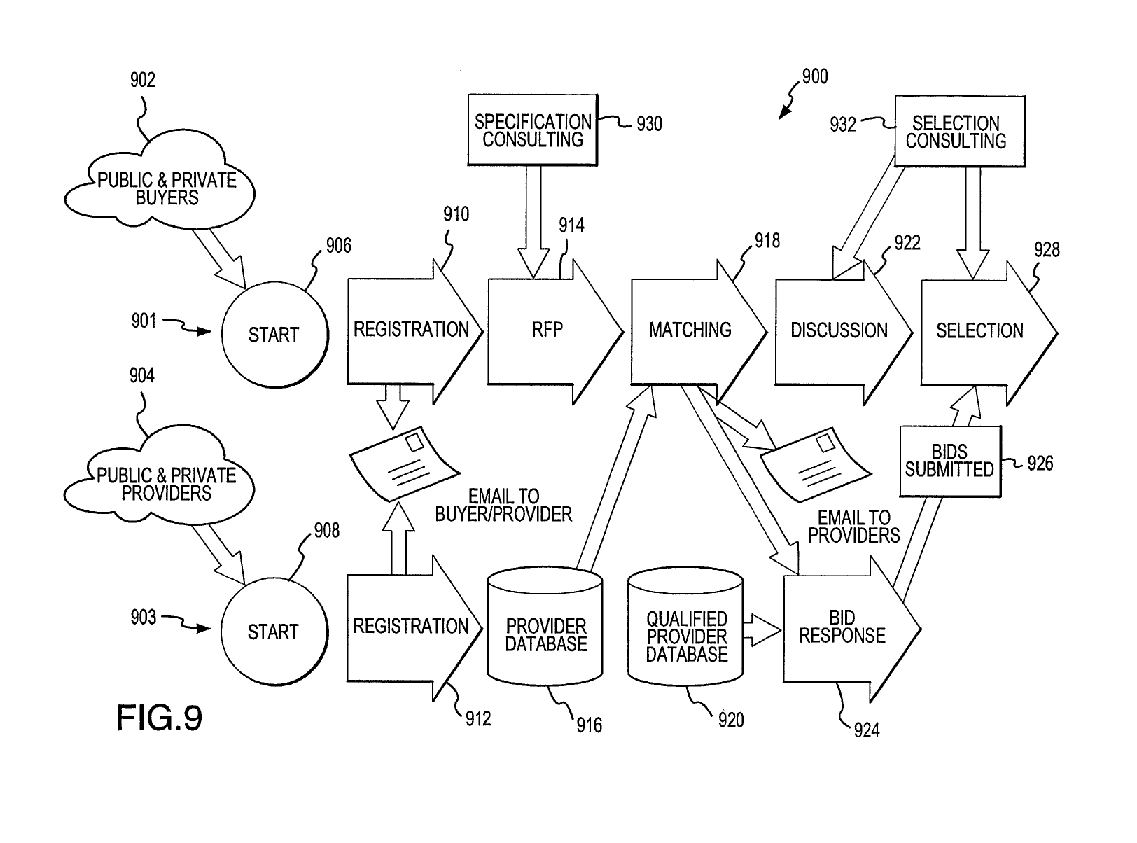

Moreover, additional features, modules and components can be suitably implemented. For example, in accordance with an exemplary embodiment, and with reference to FIG. 9, another exemplary method and system 900 for outsourcing IT projects and services is illustrated.

In accordance with this exemplary embodiment, method and system 900 suitably comprises a buyer component 901 and a provider component 903. Buyer component 901 suitably comprises a group of buyers 902 comprising public or private buyers, as well as several modules and components configured for performing registering, requesting, matching, discussing and/or selecting functions for outsourcing IT projects and services. Provider component 903 suitably comprises a group of providers 904 comprising a public and private IT providers, as well as several modules and components for performing registering and/or bidding functions for outsourcing IT projects and services. While the various modules and components can operate independently from one another, such modules and components can be configured to operate in connection with other modules and components in a comprehensive system for outsourcing IT projects and services, e.g., a registration module 910 may suitably operate in conjunction with a registration module 912, or the features and functions of registration modules 910 and 912 may be suitably combined into a single module. To facilitate an understanding of the various modules and components, rather than describing buyer component 901 and provider component 903 separately, an concurrent explanation of components 901 and 903 will be provided.

To initiate the outsourcing process, buyers 902 and sellers 904 can suitably interface outsourcing system 900 through start modules 906 and 908. Start modules 906 and 908 can suitably comprise any initialization process for enabling a buyer or provider to interface outsourcing system 900. For example, this initialization process can comprise various forms and steps, such as the accessing of outsourcing system 900 through Internet access, or any other communication network or protocol. As will be described in more detail below in accordance with an exemplary embodiment, with momentary reference to FIG. 12, buyers 902 and providers 904 can utilize, for example, a client machine 1202 to access outsourcing system 900 resident on host server 1206 through an IP network 1204.

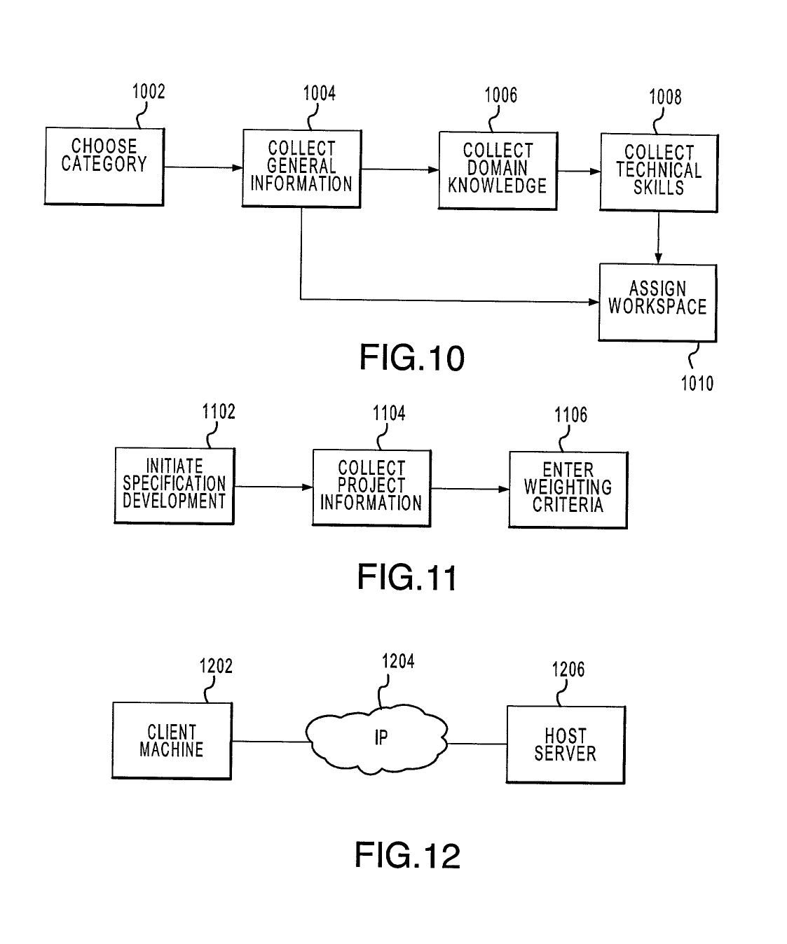

Once buyers 902 and sellers 904 obtain access to outsourcing system 900, a registration process can occur. In accordance with this aspect of the present invention, registration module, such as a registration module 402, suitably comprises a buyer registration module 910 and a provider registration module 912 that provides a mechanism for facilitating the creation of a secure workplace or operation for buyers and providers of IT projects and services, with the workplace containing various levels of buyer and provider information. In accordance with an exemplary embodiment, with reference to a FIG. 10, a registration process can comprise a choose category step 1002, a collect general information step 1004, a collect domain knowledge step 1006, and a collect technical skills step 1008. In choose category step 1002, a client, i.e., a buyer 902 or provider 904, can suitably select from a category of services and projects for buyer 902 to procure, or for provider 904 to offer or market. For example, a category for software development, for services such as IT administration, for networks or for consulting can be suitably selected.

Upon selecting a category of services in step 1002, collect general information step 1004 can be utilized to suitably collect information regarding the buyer 902 and provider 904, such as, for example, the identification, the history, the address, the number of employees and other resources of the businesses, and other like information of buyer 902 and provider 904. Upon buyer 902 entering in the general information in step 1004, the registration process of buyer 902 is essentially completed. With respect to provider 904, additional information can be collected in step 1006 and 1008.

In collect domain knowledge step 1006, data and information of provider 904 regarding areas or domains of knowledge and expertise can be identified. For example, a provider 904 can signify experience in fields such as healthcare, biotech, legal, artificial intelligence, telecommunications, financial services and the like. In addition, other areas of expertise such as data mining and warehousing, web and Internet technology, payment systems, security systems, information systems and the like can be suitably identified and selected by provider 904. Any other area of knowledge or expertise that can outline the experience of a provider 904 can also be suitably identified and listed in step 1006.

In collect technical skills step 1008, data and information of provider 904 regarding technical skills and expertise can be identified within a domain or area of expertise. For example, technical skills within the area of database platforms, programming languages or web or Internet technologies, such as Oracle, XML, Java and Javascript, assembly, COBOL, HTML, Windows, SQL server or any other platforms, languages and technologies can be suitably identified. As a result of the collection of information in steps 1004, 1006 and 1008, outsourcing system 900 can suitably utilize the collected information during a matching process to suitably match RFP inquiries with the most qualified providers 904.

Upon identifying and entering areas of knowledge, expertise and technical skills in steps 1004, 1006 and 1008, in accordance with another exemplary embodiment of the present invention, outsourcing system 900 can also suitably assign a secured workspace area for buyers 902 and providers 904 in a step 1010 to facilitate access to the various modules and components, such as RFP, selection and discussion modules. Moreover, as circumstances change for a provider 904, the collected data and information can be suitably accessed and updated through the secured workspace areas.

While exemplary outsourcing system 900 illustrates separate start modules 906 and 908, it should again be noted that such modules can be suitably incorporated or otherwise combined with registration modules 910 and 912, e.g., start module 906 combined with registration module 910, and start module 908 combined with registration module 912. Moreover, other combinations are equally plausible in accordance with other exemplary embodiments of the present invention.

In addition, in accordance with another exemplary embodiment, outsourcing system 900 can also include a provider database 916 configured for storing information and data collected with respect to providers 904. Provider database 916 can comprise any conventional database for storage of data and information. As a result, provider database 916 can suitably provide a database of providers 904 for matching module 918 to suitably utilize during the matching process.

Once buyers 902 and providers 904 have suitably registered within system 900, any RFP inquiries can be suitably developed by buyers in RFP module 914. RFP module 914 suitably comprises a comprehensive request for proposal (RFP) mechanism for permitting one or more buyers 902 to provide outsourcing system 900 with an RFP for specific IT project or service solution needs, requirements and/or specifications. In accordance with an exemplary embodiment, with reference to FIG. 11, a mechanism for RFP module 914 can be comprised of various processing steps for providing an RFP inquiry, including an initiate specification development step 1102, a collect project information step 1104, and an entering weighting Criteria step 1106.

In initiate specification development step 1102, a buyer 902 can suitably initiate the Development of the specifications for one or more IT projects and services. In accordance with an exemplary embodiment, a buyer 902 can suitably select an RFP template provided for each such IT project request. In addition, each RFP template can be suitably associated with buyer 902 to facilitate the initiation of specification development, and can be utilized for later recall and application.

Once the initiation step 1102 is completed, a step 1104 of collecting project information can be suitably conducted. This project information can comprise many types and forms of information, including any general project information, such as simple project details like time sensitivity, pricing structure, project duration and the like, any technical information, such as required domain knowledge, related specific technical skills, and managerial experience, any statements of work, as will be described in more detail below, and any related supporting documents.

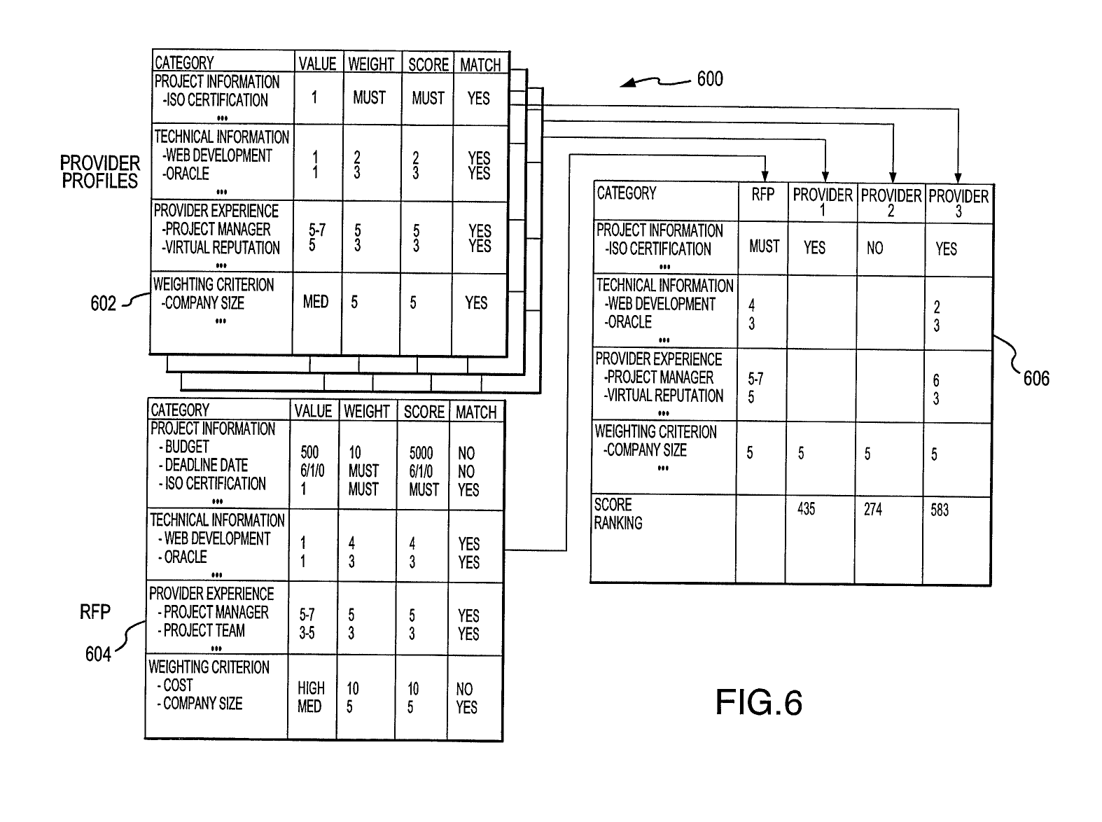

Upon collecting the project information in step 1102, buyer 902 can suitably provide weighting criteria to the specified data collected in step 1104. The weighting criteria can be suitably applied by buyer as desired to any of the specified data collected, or if desired, to all of the specified data elements. The weighting criteria can suitably comprise any range of scalable factors. For example, the scalable factors can comprise a ranking of low, medium or high interest, or various ranges in between. In addition, the scalable factors can be ranked numerically, e.g., from a scale of 1 to 5 or 1 to 10, such as the scaling weight factors for the RFP profile illustrated in FIG. 6. Accordingly, any manner for scaling factors can be utilized in accordance with weighting step 1104.

Upon buyer 902 providing an RFP inquiry into RFP module 914, such as the completing of steps 1102, 1104, and 1106, outsourcing system 900 can suitably facilitate the matching of qualified providers with the RFP profile of buyer 902. To facilitate the matching of providers and buyers, outsourcing system 900 suitably comprises a matching module 918. Matching module 918 suitably comprises an intelligent search and matching engine configured for analyzing data and criteria obtained from buyers 902 and contained within RFP module 914 to suitably match providers 904, such as provider profiles stored within provider database 916, based on the data elements captured from the providers during registration module 912. Through the matching process, matching module 918 can be configured to match only qualified providers within database 920, or only with providers the buyer currently utilizes, or match with both groups of providers.

To assess the profile of provider 904 to determine if appropriate for a given buyer 902, a technical details match can be conducted by matching module 918. In this matching process, the domain knowledge captured and assessed from the RFP inquiry can be suitably matched against the provider profile to return a match that either meets or exceeds the required knowledge base. With reference to FIG. 6, an exemplary matching process is illustrated. In this example, for each category in an RFP table 604, the matching module 918 can attempt to match with a corresponding category in a provider profile 602 obtained from registration module 912. In accordance with this aspect, matching module 918 suitably assigns an appropriate score for each category in the RFP table 604 and the provider profile 602. Values entered for each category can be assigned, for example, a score between 1-5, with a default of 1, or a score ranging from 1 to 10, or any other variation. Moreover, a value of low, medium or high, or other ranges in between, can be suitably assigned. All values or scores can be suitably assigned by a user administration with the outsourcing system 900 when deploying matching module 918, or the user administration can assign or change these values at any time during the outsourcing process.

In addition to the technical information skills, the project management skills can also be assessed. For example, with buyer 902 having set a minimum criteria level and providers 904 having entered the average experience of a project manager for provider 904, in the event the average experience meets the minimum criteria, a set value may be assigned to the score or rank of provider 904, such as, for example, 5 points. In the event the average experience exceeds the minimum criteria, an extra point may be added for each range of age above the minimum criteria, e.g., for every three years above the minimum criteria, while one or more points may be subtracted for each range of age below the minimum criteria.

In addition, other areas and qualifications can be assessed from the data captured from the RFP module 914, such as the company size and structure of the provider 904. Values may be suitably assigned depending on the criticality of these features to buyer 902. Further, the complexity of a project and the time criticality may be assessed. For example, for many projects, the complexity of the project and the time criticality work provide a significant strain on resources of a provider 904. As a result, larger companies with abundant manpower and resources can generally handle more efficiently the complex and time critical projects than smaller companies. Thus, in accordance with an exemplary embodiment, to assess the impact of provider 904 for more complex and time critical projects, an evaluation component can be computed by multiplying a value assigned to the level of complexity to a value assigned to the time criticality. The values can be suitably assigned by user administration and selected by buyer 902 as appropriate. Upon computing the evaluation component, an assessment can be conducted a point value may be assigned depending on the size of the provider 904. For example, if the evaluation component is less than 9, then 10 points can be assigned to a small provider, 11 points to a medium provider, and 12 points to a large provider. If the evaluation component is at least 9 but less than 12, then 10 points can be assigned to a small provider, 12 points to a medium provider, and 13 points to a large provider. Moreover, if the evaluation component is at least 12 but less than 16, then 5 points can be assigned to a small provider, 10points to a medium provider, and 1 points to a large provider. Again, it should be noted that any suitable range of values may be assigned by user administration or buyer, depending on the criticality of company size and time to the project as determined by buyer 902.

Further, a quality verification for provider 904 may also be conducted. For example, a determination as to whether a provider 904 is ISO−5, SEICMM−7, or ISO+SEI/CMM−8 certified, may be conducted, with a value assigned to each certification held by provider 904. Moreover, a separate quality verification can be conducted, for example, by selecting a score from a verification table and assigning a value from 1 to 10, and then adding that score to the total. Like the other features described above, this process can also have manual intervention, such as user administration function.

Still further, other areas such as the performance history, e.g., past performance for each rating from matching table 606, and the infrastructure, where values from a verification table can be selected, can also be completed. In addition, any other criteria deemed of importance or relevant may be entered by user administration on a requirements or case-by-case basis.

As a result of matching module 918, various providers 904 can be suitably scored and ranked based on their registration information in module 912 and the information within RFP module 914 to provide matching table 606. Accordingly, from the results of matching table 606, outsourcing system 900 can suitably provide a qualified list of providers 904 for bidding on an FP provided by buyer 902 to RFP module 914. These qualified providers can be suitably compiled within a qualified provider database 920, or any other manner of storing identified candidates for bidding.

Having identified a matched group of providers 904 based on various weighted criteria, for example, as may be identified and stored in a qualified provider database 920, outsourcing system 900 may be prepared to initiate the bidding process. In this regard, discussion module 922 and bidding module 924 suitably comprises a mechanism for facilitating the collaboration between buyers and providers to obtain an improved understanding of the RFP and desired IT project and services to facilitate an effective bidding process. For example, in the event a provider 904 is identified as a qualified matching provider, e.g., within qualified provider database 920, provider 904 can be suitably notified in various manners, and can receive the RFP of buyer 902 in the workspace of provider 904. To allow providers to collaborate with buyers for better communication and understanding of the RFP requirements, module 922 can provide secure channels of communication between a buyer and a single provider or a group of providers. In addition, all modes of communications, e.g., whether asynchronous or synchronous, can be suitably monitored by module 922, with transcripts made available according to preset user rights. The channels for communication can include web conferencing or teleconferencing, all of which can be suitably scheduled on the workspace of buyer 902 and provider 904.

For the bidding functions, module 924 can suitably provide bid templates to the selected providers in their private, secure workspace. The bid templates can be configured to be unique based on the type of RFI/RFP inquiry submitted by the Buyer 902. Each provider 904 selected to bid on a project can be provided a deadline for submittal that is determined by the buyer 902. provider 904 can suitably submit bidding information 926 which can include, for example, design and development cost estimates, man-hour estimates, material cost estimates and the like. In addition, provider 904 can upload any supporting information that may be useful in the evaluation of the bid of provider 904.

After the bid deadline has passed, an automatic notification can be submitted to the buyer 902 and all selected providers 904. The notification can be suitably submitted to providers 904 to indicate that the bids will be made available to the buyer 902 and suitably scored, ranked and short-listed and/or selected during the process of selection module 928. In addition, any qualified providers 904 that did not submit a bid can also be encouraged to bid on future projects of the buyer or other buyers 902.

Upon completion of discussion module 922 and bid response module 924, a selection module 928 is configured to facilitate selection by buyer of a qualified provider from database 924 for the RFP inquiry. In accordance with an exemplary embodiment, selection module 928 suitably comprises an intelligent bid selection engine configured to score and rank the bids of provider 904 based on buyer 902 specified selection criteria.

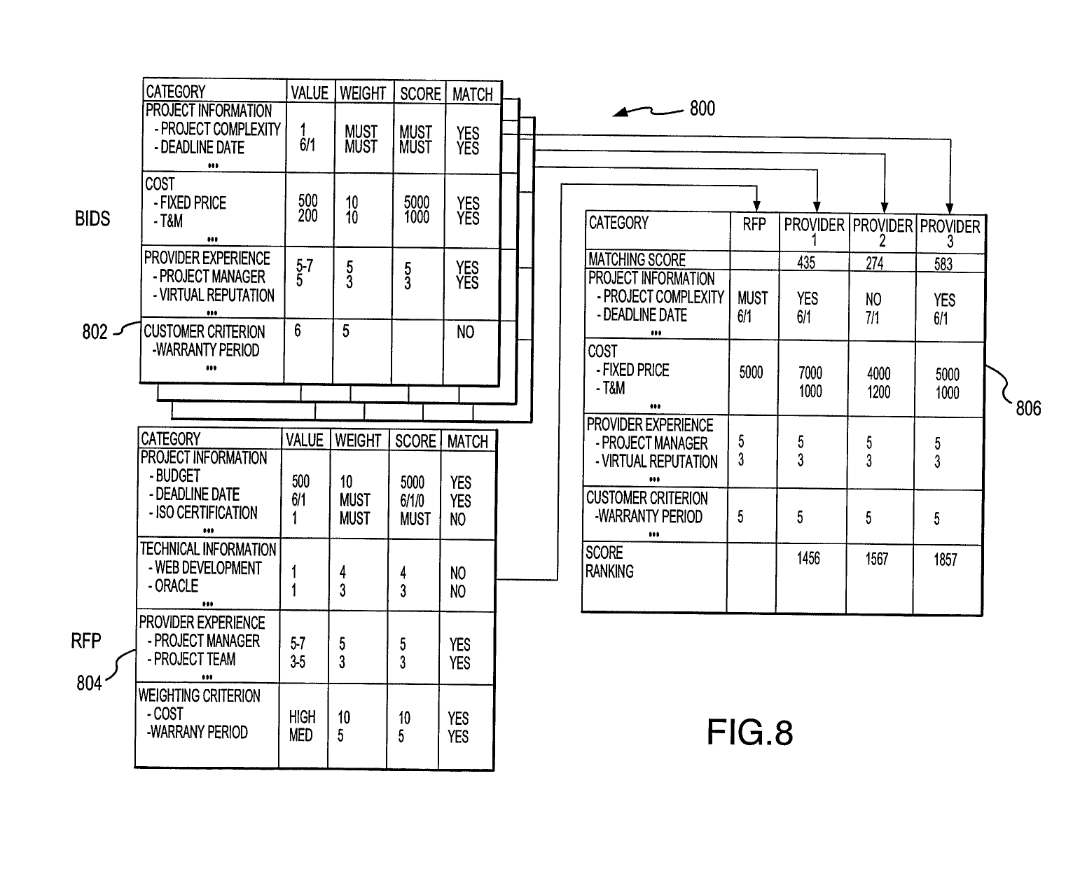

During the selection process, the bid selection criteria may be suitably assessed by buyer 902 through use of selection module 928. With reference to FIG. 8, an exemplary selection profile 800 is illustrated. This can include the conducting of a further technical details match. For example, the technical details captured from the RFP module 914 can be provided in an RFP table 804 and matched against a provider bidding profile 802 to return a match that meets or exceeds the required knowledge. For example, the associated logic could comprise for each check box or other selection element in RFP module 914, e.g., within RFP table 804, a matching with text/checkbox or selection element in provider bidding profile 802, providing an appropriate score for each element. In addition, any values entered in the provider bidding profile can be assigned a score between 1-5, with a default of 1, or a score ranging from 1 to 10, or any other variation. Moreover, a value of low, medium or high, or other ranges in between, can be suitably assigned. Again, all scores can be assigned or changed by a user administration function when deploying the module, or at anytime during the outsourcing process.

In addition, the project management skills can again be assessed by comparing the values from RFP table 804 against the values in provider bidding profile 802. For example, the average experience of a project manager can be determined, with different values assigned depending on whether the project manager experience meets, exceeds or falls below the minimum selection criteria of the RFP inquiry. Moreover, the company size can be assessed by the captured data in RFP module 914 by a method similar to that above in provider matching criteria.

Further, the prior relevant project experience can also be evaluated. For example, the selection module 928 can collect prior relevant project experience in profiler bidding profile 802 to provide details of average team size, duration of projects, and the like. In addition, a keyword match, e.g., a search for Meta Data, Rule-Based data and the like, can be conducted to determine the amount and relevancy of similar projects. The ratings and values assigned to each element can be provided by similar methods to those described above.

In accordance with an exemplary embodiment, a rating and scoring system can be provided by identifying any relevant or similar projects, and then computing an evaluation factor based on the project team size multiplied by the duration of the project, e.g., the number of weeks. For example, if the evaluation factor, i.e., the project team size multiplied by the duration of the project, is less than 25, then 1 point can be assigned to the score for relevant project experience; if less than 50, then 2 points can be assigned, if less than 75, then 3 points can be assigned, and so on. Moreover, any other values or ranges of evaluation factors can be suitably implemented to compute a score for the relevant project experience of provider 904.

Moreover, the quality, performance history, verification, and infrastructure features can also be suitably assessed by the processes described above in matching module 918 for matching provider criteria, e.g., values can be assigned depending on various criteria set forth by buyer 902.

After assessing the above elements, the estimated effort required for the project can be determined. To conduct this step, values can be taken from profiler bidding profile 802. The effort required can be calculated as the average team size available for the project multiplied by the duration required for the project. This data and result can also be collected, queried and assessed separately for projects located off shore and on site, as well as projects provided with long and short lead times, or any other definable criteria capable of providing additional assessment information for buyer 902.

In addition, the corresponding costs can be evaluated and determined. For example, the development cost including various fees, can be determined and broken down for both on site and off shore projects, including any travel, boarding and lodging, and other expenses. Further, the resulting data from all costs can also be accumulated, and scores can be assigned based on a median calculated for all providers. 904.

For example, if the resulting costs data is greater than two times the median score, no points are assigned; if more than 50% greater than the median, 4 points can be assigned; and if more than 25% greater than the median, 6 points can be assigned. On the other hand, if the resulting costs data is 25% less than the median, 8 points can be assigned, and if the costs data is 50% less than the median, 10 points can be assigned. In addition, other ranges and number can be suitably implemented depending on the desired weight of buyer 902 with respect to cost figures. Moreover, the levels of evaluation, e.g., greater than 25%, less than 50%, can be suitably increased, with the assigned points suitably prorated accordingly.

Moreover, a warranty period for the project can also be determined, with a rating system, such as, for example, assigning 5 points for a warranty period greater than 90 days, 4 points for warranty period less than 90 but greater than 60 days, 3 points for a warranty period less than 60 but greater than 30 days, 2 points if the warranty period is less than 30 days, and no points if no warranty is provided: Further, any other range of values may be suitably selected and determined by user administration depending on the weight given by buyer 902.

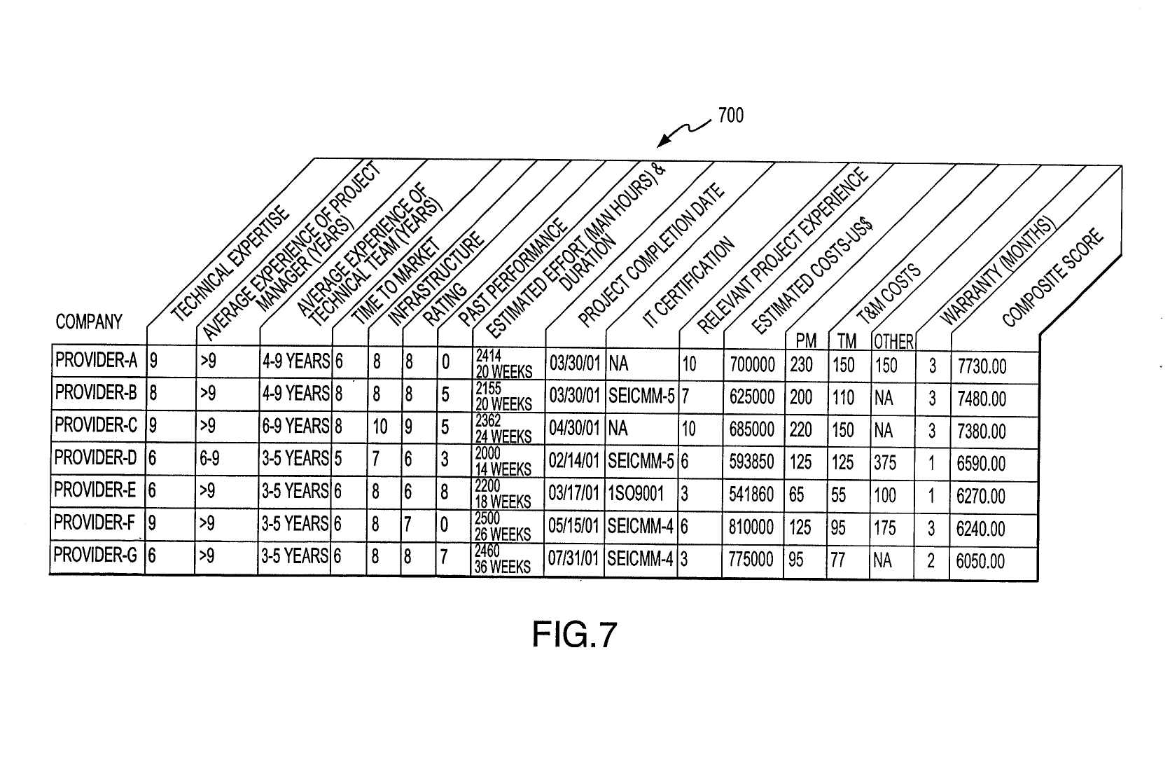

As a result, a thorough bidder profile 802 can be developed to facilitate selection by buyer 902. In accordance with another exemplary embodiment, to further facilitate the selection process, a selection matrix can be developed. With reference to FIG. 7, an exemplary selection matrix 700 is illustrated. For example, selection module 928 can be configured to suitably score, rank, and provide results to buyers 902 in a readily comparable format, for example matrix format 700, along with complete bid documents from the providers 904. In addition, the ranking provided by selection module 928 can suitably take into consideration levels of importance and weights specified by the buyer for the data and criteria submitted in RFP module 914 with the responses submitted by the providers 904 to create a selection matrix 700 that enables a buyer 904 to compare the bids in a one-to-one fashion.

Through use of selection matrix 700, buyer 902 can suitably select a provider 904 for the RFP inquiry based on the composite scores only, or upon other substantive factors deemed important to buyer 902. In addition, buyer 902 can select a short-list of providers 904 for xonducting further interviews, prior to selecting the winning bid. Upon selecting a winning bid from a provider 904, the IT project can commence.

As a result of the above modules, elements and components, outsourcing system 900 can be implemented to enable buyers and IT providers to confer and agree in a very efficient, neutral and intelligent manner for the planning, outsourcing, and/or procuring of information technology projects and services. However, it should be noted that while the systems and methodologies include a process for suitably selecting and matching buyers of information technology with appropriate providers, various of the above steps, functions and features may be suitably modified or deleted, and/or arranged in various manners, and that the above description is merely for illustrative purposes. For example, while provider database module 916 and qualified provider database module 920 are illustrated as separate modules, the features and function can be suitably incorporated into or otherwise combined within a single database module, or with registration modules 910 or 912, or any of the other modules in accordance with various other exemplary embodiments of the present invention.

In addition, in accordance with other exemplary embodiments, additional modules can be implemented within outsourcing system 900. For example, a specification consulting module 930 can also be suitably included, such as in connection with RFP module 914, to provide consulting assistance in developing the RFP specification. In addition, a selection consulting module 932 can also be included to facilitate the operation of discussion module 922 and/or selection module 928. Such consulting modules 930 and/or 932 can comprise the use of rule-based, cased-based or other artificial intelligence applications, or human intervention, to provide consulting assistance.

Accordingly, outsourcing system 900 can be implemented to enable buyers and IT providers to confer and agree in a very efficient, neutral and intelligent manner for the planning, outsourcing, and/or procuring of information technology projects and services. Further, instead of the typical six-month period for conventional outsourcing methods, outsourcing system 900 can be conducted in significantly less time, for example, as little as three weeks. Accordingly, provider 904 is ready to initiate work on the IT project. However, it may be desirable for buyer 902 to have a mechanism for overseeing the IT project, including any milestones and deadlines. In accordance with another aspect of the present invention, a system and method for outsourcing IT projects and services can also be configured for delivering and/or managing the IT projects and services.

In accordance with this aspect of the present invention, a project administration method and system can be provided to facilitate the delivering and/or managing the IT projects and services. In accordance with an exemplary embodiment, the project administration method and system can be configured to enable the buyer and the provider to oversee the delivery of the IT project, such as by using a browser-based application, to provide a secure workspace where project teams can suitably collaborate, conduct online conversations, such as with discussion module 922, track project milestones, monitor service levels, resolve issues, solicit feedback and/or authorize payment.

In addition, in accordance with another exemplary embodiment, the project administration method and system can enable the buyers and providers to administer the project entirely online, from anywhere in the world. This can include the ability to evaluate and track project milestones, and to monitor, update and analyze project performance metrics with detailed tables and graphs. In addition, the project administration system can be configured to submit and track changes to milestone dates, any failures to meet threshold metrics criteria, and any critical issues related to project completion. Moreover, the project administration system can be configured to review a content-based weekly or other periodic report that can provide an overview of the status of the project, and can provide various features such as a project milestones table, a performance metrics table and graphs, the access to all issues that have been raised, the ability to interact via online conferences that are archived for future reference, and the ability to facilitate financial transactions tied to completion of project milestones.

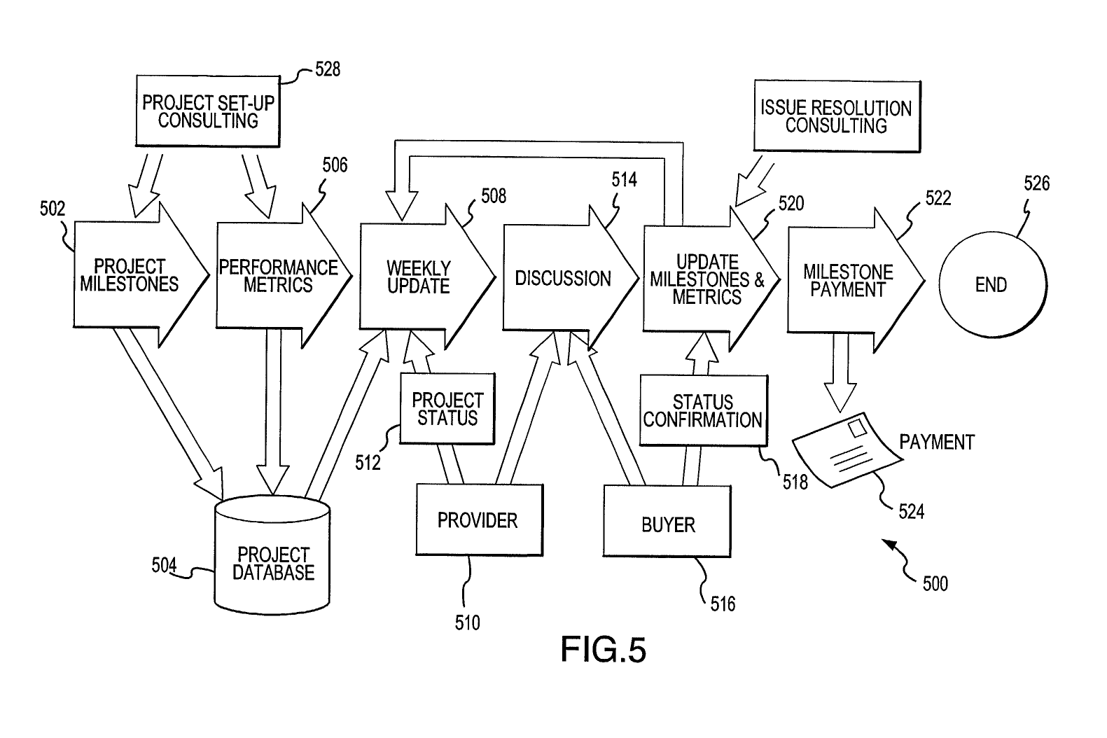

With reference to FIG. 5, an exemplary project administration system 500 is illustrated. In accordance with this embodiment, project administration system 500 suitably comprises a project milestones module 502, a performance metrics module 506, a periodic update module 508, a discussion module 514, an update performance module 520, a milestone payment module 522, and a project end module 526. Project milestones module 502 comprises a table containing various milestones, e.g., various events, tasks, or steps required or otherwise to be performed for completion of the project, and which can be selected by either a buyer 516, a provider 510, or both. Project milestones module 502 is suitably configured for tracking the percentage of completion of each project, including the percentage of completion for event, task or step. Performance metrics module 506 is configured for tracking the performance criteria along the path of a project, e.g., from module 502 through module 526. As a result, issues deemed important to buyer 516 or provider 510 can be suitably tracked and archived, e.g., stored within project database 504, for future reference. In accordance with another exemplary embodiment, a project set-up consulting module 528 can be included to facilitate the tracking of project milestones and performance metrics.

As the project progresses, the milestones and performance metrics can be periodically updated within module 508. Update module 508 can be configured for various update periods, such as daily, weekly, monthly or any other period. In the exemplary embodiment, update module 508 is configured for a weekly update. Upon completion of the updating process, various report configurations can be provided to buyer 516 and provider 510.

For updating of the project, a provider 510 can suitably update a project with a project status 512 provided to update module 508. For confirmation, a buyer 516 can suitably review project status 512 and comment and discuss with provider 510 in discussion module 514. Once buyer 516 approves and confirms the project update status, buyer 516 can provide a status confirmation 518 to update performance module 520. Update performance module 520 is configured to update the project milestones and performance metrics provided within modules 502 and 506. Upon receiving status confirmation 518, update performance module 520 can suitably provide updated performance criteria to update module 508 for reporting to provider 510 and buyer 516. To facilitate resolution of any issues or disputes that may occur that are not resolved within discussion module 514, in accordance with another exemplary embodiment, project administration system 500 can also include an issue resolution consulting module 530 configured for providing consulting assistance to buyer 516 and provider team 510.

As each milestone is reached or completed, buyer 516 has an option to provide or release a payment 524 to provider 510 through use of milestone payment module 522. Milestone payment module 522 can comprise any payment distribution system. In an exemplary embodiment, milestone payment module 522 can be configured for electronic payment authorization to provider 510.

The process of providing project status 512 to update module 508, discussing of project status in module 514, and providing status confirmation 518 to update performance module 520 can suitably continue until the project is completed. Upon completion, project end module 526 is provided for a final review and confirmation of project completion. This can include the making of any final payments or refunds, the return of any materials of buyer 516 and provider 510, and the fine tuning or adjustment of any projects. In addition, project end module 526 can also be configured to facilitate and acquire feedback from buyer 516 and provider 510. For example, in accordance with another exemplary embodiment, the feedback received as a result of the project tracking process can be suitably provided to a virtual reputation system within outsourcing system, as will be described in more detail below.

As a result of the above modules, elements and components, an exemplary outsourcing system can also be configured with a project administration method and system to facilitate the delivering and/or managing of the IT projects and services. However, it should be noted that while the systems and methodologies include a process for delivering and/or managing information technology projects and services, various of the above steps, functions and features may be suitably modified, added, deleted, combined and/or arranged in various manners, and that the above description is merely for illustrative purposes. For example, update module 508 and performance update module 520 could be suitably combined into a single update module. In addition, status confirmation 520 could be provided directly to update module 508. Other similar modifications are contemplated within the various exemplary embodiments of the present invention.

As discussed, various other features, modules and components can be implemented within the matching, selection and administration functions of the outsourcing system. In accordance with another exemplary embodiment of the present invention, with reference to FIGS. 5 and 9, a statement of work can be provided to further facilitate the selection and administration functions of the outsourcing system. In accordance with this exemplary embodiment, an automated statement of work can be captured in the form of questions and responses from the buyers in the RFP profile within RFP module 914. The statement of work data can be carried forward to the provider's bid profile within bidding module 924 where providers can respond with the required information. Other details can also be captured in statement of work including project milestones from milestone module 502, any resources for each milestone and payment percentage for each milestone. After the buyer selects the final provider to execute the project or service, the information from the statement of work can be automatically populated in a milestone table with milestone module 502. In addition, the provider and buyer can further update and customize the statement of work as desired.

In accordance with another exemplary embodiment, again with reference to FIGS. 5 and 9, a virtual reputation system can be provided. The virtual reputation system suitably comprises a background evaluation of the provider's capabilities as the provider goes through the outsourcing process, and can be comprised of three subsystems, including a bid reputation, project reputation and process reputation subsystem. The bid reputation subsystem evaluates the quality of the provider's bid each time the provider responds to an RFI/RFP inquiry through bidding module 924, e.g. the bid subsystem evaluates the adherence to buyer specified formats, timely submission of responses, mode of response, presence of a bid proposal as attachment, and presence of standard information in the bid proposal. The project reputation subsystem evaluates the quality of the provider as they complete a project, such as during completion of end module 526. I n addition, the project reputation subsystem suitably tracks milestone completion successes, performance benchmarks on project metrics, number of issues raised with severity level, responsiveness, communication and others during use of modules 502 through 526. The process reputation subsystem tracks the provider's performance through all other phases of the outsourcing process. Process reputation subsystem becomes active at the time of registration, i.e., during registration modules 910 and 912, and measures the provider's accuracy and quality throughout the outsourcing system. Further, virtual reputation scores can be accessible at matching module 918 and selection module 928, including the selection matrix.

In accordance with another exemplary embodiment of the present invention, a quality assurance module can be included. The quality assurance module can suitably comprise an intelligent, algorithm-based technology that is built on OOPs concept and is modular in nature. The quality assurance module can assess providers on different key performance indicators (KPIs) necessary for executing a project. The quality assurance module can be carried out in association with global quality assurance certification programs, e.g., BVQI, TUV and BSI. The quality assurance module can be implemented in at least two phases, including a web based and an onsite phase.

The quality assurance module assessment can include a qualitative and quantitative assessment, that results in a comprehensive report on a provider's capabilities to execute a project, including a standardized rating system that may be used across providers. The quality assurance module assessment can also provide deep insight into an organization's ability to meet the buyer's requirements. The quality assurance module can be administered annually, or as requested, and provides an updated status. The KPIs covered under the program can include, among others, domain knowledge and experience, technical and functional skills, infrastructure and development environment, quality assurance processes and systems, performance management, delivery and risk management, pricing models, project management skills, human resource initiatives, and customer orientation.

As briefly discussed above, the outsourcing method and system can be implemented in various communication manners and network configurations. For example, with reference to FIG. 12, buyers and providers can utilize, for example, a client machine 1202 to access an outsourcing system resident on host server 1206 through an IP network 1204. Client machine 1202 can comprise any conventional processor, computer or other like device for providing access to a communication network for connection to the outsourcing system. To facilitate the interfacing to the communication network, client machine 1202 suitably includes a web browser. IP network 1204 comprises any conventional IP network configured for Internet-based communications. In addition, rather than, or in addition to, an IP network, any other type of communication protocol can be suitably implemented.

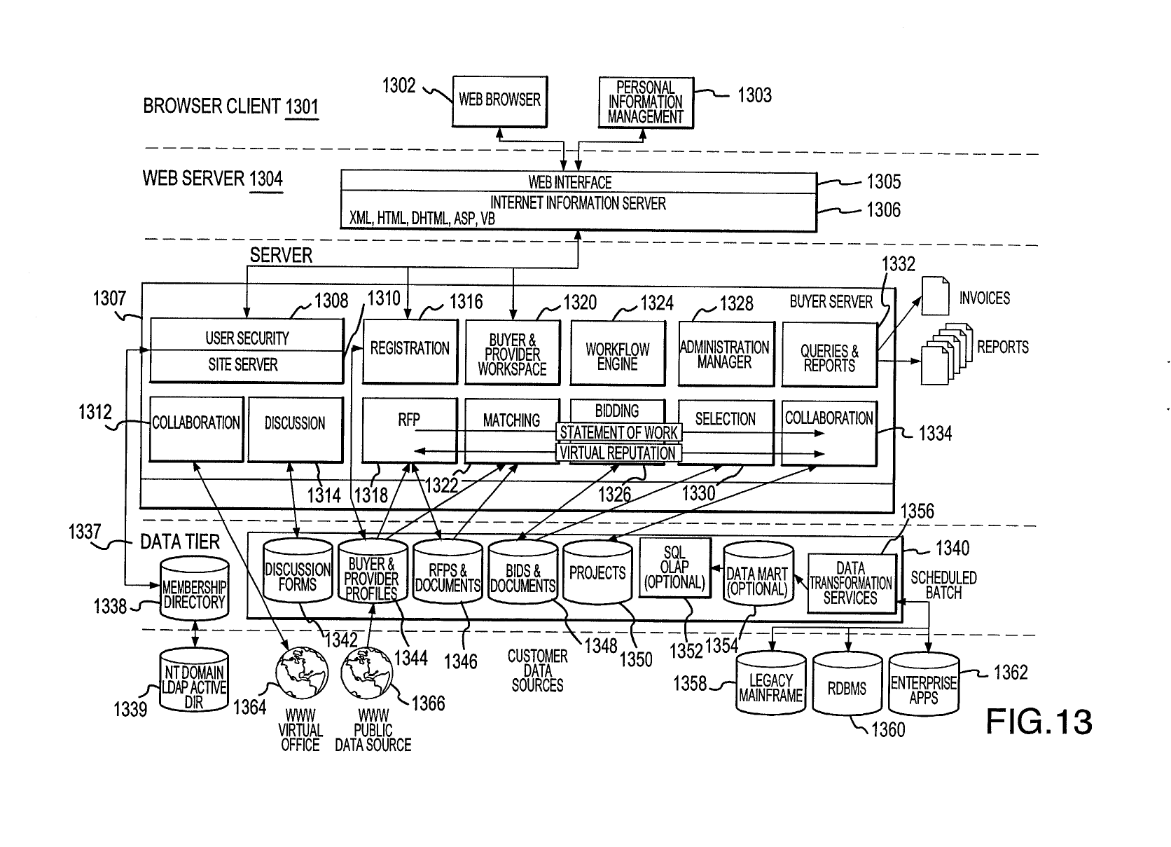

With reference to FIG. 13, an exemplary system 1300 for facilitating the outsourcing process is illustrated. However, it should be noted that the exemplary system is merely for illustration purposes, and that the various components, modules and devices can be suitably replaced, interchanged, combined or otherwise modified in accordance with various other embodiments. System 1300 suitably comprising a client system and a host system for facilitating the communications between buyers and providers during the outsourcing process. In accordance with an exemplary embodiment, system 1300 can be suitably configured in a 3-tier architecture. For example, a tier 1 database layer can be provided, using for example an SQL database, to store procedures. Tier 1 can also be triggered on an SQL data store. A tier 2 business object layer can also be provided, and which can be built using COM+technology. Meanwhile, a tier 3 presentation and interface layer can be provided, and which can comprise ASP, VBScript, XML and HTML programming components. In addition, both EDI and XML integration can be suitably supported. Further, system redundancy and load rebalancing can be suitably addressed by server clustering techniques, as well as available standby servers.

The client system suitably comprises a browser based component 1301, having for example a web browser 1302 and a personal information and management component 1303, e.g., MS Outlook as provided by the Microsoft Corporation. For interfacing with the host system through an IP network, a web server 1304 can be provided. Web server 1304 suitably comprises a web interface 1305 and an Internet information server 1306. Web interface 1305 comprises any type of web interface, while server 1306 is suitably configured for various programming formats, such as XML, HTML, DHTML, ASP and VB configurations.

The host system suitably comprises a host server 1307 configured to provide various functions. For example, server 1307 can include a user security component 1308 and a site server 1310. Security component 1308 is suitably configured to ensure the integrity and security of data received and stored within system 1300. For example, security component 1308 can include an architecture that provides a separation mechanism to isolate the critical data layer from unauthorized access from any upper layers. In addition, encryption layers, as well as multiple firewall layers to protect the data stored, can be included as well. Moreover, user access can be configured for password protection, with other features such as automatic timeouts for user inactivity also suitably configured for use and protection.

Server 1307 can also suitably include various functional modules as described above, such as a registration module 1316, an RFP module 1318, a workspace module 1320, a matching module 1322, a workflow engine module 1324, a bidding module 1326, a discussion module 1314, a selection module 1330, an administration module 1328, collaboration modules 1312 and 1334, and a reporting module 1334. While server 1307 can be configured for communication to a data tier 1337, server 1307 can also be configured to communicate to data sources for buyers and sellers. For example, collaboration module 1312 can be configured to interface with a virtual office environment for facilitating meetings, discussions and the like.

Modules 1312 through 1334 can be suitably configured to communicate with a data tier 1337 to access data for processing. Data tier 1337 is configured for storage of various data elements and information. Data tier 1337 can include a membership directory 1338 containing general information for any previous buyers and providers that have registered.

In addition, data tier can comprise data storage that can be provided on various other storage components, such as a discussion forum component 1342, a provider profile component 1344, an RFP component 1346, a bidding component 1348, a project component 1350 and a data transformation services component 1356. In addition, an SQL OLAP component 1352 and a data mart component 1354 can also be included.

Data tier 1337 can also be configured for communication directly to data sources of buyers and providers. For example, membership directory 1338 can also be configured to communicate with a buyer or providers active directory 1339, while provider profiles 1334 can be configured to obtain information from a public data source 1366, such as Dun & Bradstreet resources. Moreover, data transformation services component 1356 can communicate with a legacy mainframe 1358, an RDBMS component, and buyer and provider applications components 1362 for the transfer and use of addition data utilized in the evaluation, matching and selection processes.

The present invention has been described above with reference to various exemplary embodiments, including internet-based and software-based. However, those skilled in the art will recognize that changes and modifications may be made to the exemplary embodiments without departing from the scope of the present invention. For example, the various processing steps dictated by the software, as well as the components for carrying out the processing steps, may be implemented in alternate ways depending upon the particular application or in consideration of any number of cost functions associated with the operation of the system. Further, the values and thresholds for the various parameters may be changed depending on any number of design criteria. Still further, the method and system can be applied to other outsourcing applications outside of information technology. Additionally, the system of the present invention may include various language translators to facilitate the operation within various foreign language countries. Moreover, the various communication links between servers, interfaces, modules or other system devices are not limited to Internet Protocol (IP) and may comprise any other communication protocol now known or hereinafter devised. These and other changes or modifications are intended to be included within the scope of the present invention.

We claim:

1. A data processing system configured for facilitating the outsourcing of information technology projects and services between buyers and providers, said data processing system comprising:
a computerized registration module configured for capturing summary and detailed information of the buyers and the providers, said computerized registration module being further configured to provide provider profiles stored in a provider database;
a computerized request for proposal module configured for developing specifications for an information technology project, said specifications comprising criteria specified by at least one of the buyers;
a computerized matching module comprising an intelligent search engine configured for analyzing said criteria specified by said at least one of the buyers, and for matching said criteria specified by said at least one of the buyers to data contained in said provider profiles to identify a group of qualified providers;
a computerized bidding module configured for providing a bidding profile for said qualified providers, said bidding profile comprising provider specified criteria configured to correspond to said criteria specified by said at least one of the buyers in said computerized request for proposal module; and
a computerized selection module comprising an intelligent selection engine configured to score said bidding profiles based on said provider specified criteria, and configured to provide a ranking of said bidding profiles, wherein said ranking of bidding profiles facilitates the selection of one of said qualified providers to provide said information technology project.

2. A data processing system according to claim 1, wherein said computerized registration module is further configured for permitting the buyers and the providers to choose a category of information technology projects and services, and is further configured for identifying domains of knowledge and technical skills of the buyers and providers.

3. A data processing system according to claim 2, wherein said computerized registration module is further configured for assigning a secured workspace within a registration database to facilitate access by the buyers and providers to said data processing system.

4. A data processing system according to claim 1, wherein said computerized request for proposal module is further configured for collecting project information based on said criteria specified by said at least one of the buyers, and is further configured for providing weighting parameters to said criteria specified by said at least one of the buyers.

5. A data processing system according to claim 1, wherein said computerized matching module is further configured to conduct a technical details match comprising a comparison of domain knowledge specified by said computerized request for proposal module and domain knowledge captured in said computerized registration module and stored within said provider profile.

6. A data processing system according to claim 5, wherein said computerized matching module is further configured to conduct a project management skills match comprising a comparison of project management criteria specified by said computerized request for proposal module and project management experience information captured in said computerized registration module and stored within said provider profile.

7. A data processing system according to claim 6, wherein said computerized matching module is further configured to conduct a project complexity, quality verification and a company structure match comprising a comparison of project complexity, quality verification and company structure criteria specified by said computerized request for proposal module and project complexity, quality verification and a company structure information captured in said computerized registration module and stored within said provider profile.

8. A data processing system according to claim 1, wherein said computerized selection module is further configured for conducting a technical details match comprising a comparison of domain knowledge criteria specified in said computerized request for proposal module and weighted by the buyer and domain knowledge information captured in said computerized bidding module and stored within said bidding profile, said selection module being further configured to provide a score associated with said bidding profile depending on the comparison with said weighted criteria specified in said computerized request for proposal module.

9. A data processing system according to claim 8, wherein said computerized selection module is further configured for conducting a project management skills match comprising a comparison of project management criteria specified in said computerized request for proposal module and weighted by the buyer and project management information captured in said computerized bidding module and stored within said bidding profile, said selection module being further configured to provide a score associated with said project management information in said bidding profile depending on the comparison with said weighted criteria specified in said computerized request for proposal module.

10. A data processing system according to claim 10, wherein said computerized selection module is further configured for conducting a relevant project experience, estimated project effort, and associated costs match comprising a comparison of project management criteria specified in said computerized request for proposal module and weighted by the buyer and relevant project experience, estimated project effort, and associated cost information captured in said computerized bidding module and stored within said bidding profile, said selection module being further configured to provide a score associated with said relevant project experience, estimated project effort, and associated cost information in said bidding profile depending on the comparison with said weighted criteria specified in said computerized request for proposal module.

11. A data processing system according to claim 1, wherein said data processing system further comprises a computerized project administration system configured for facilitating the delivering and managing of the information technology projects and services, said computerized project administration system comprising:
a computerized project milestones module comprising a table of project tasks to be performed by said one of said qualified providers, said computerized project milestones module configured with a computerized interface to permit the identification of project tasks by said at least one of the buyers and said one of said qualified providers;
a computerized performance metrics module configured for tracking performance criteria associated with performance of said project tasks; and
a computerized update module configured for updating status of said project tasks and said performance criteria on a periodic basis.

12. A data processing system according to claim 11, wherein said computerized project administration system further comprises:
a computerized milestone payment module configured to provide a payment to said one of said qualified providers when said project tasks are completed and verified by said at least one of the buyers.

13. A data processing method for facilitating the outsourcing of information technology projects and services between buyers and providers, said data processing method comprising the computer-implemented steps of:
registering the buyers and providers by capturing summary and detailed information of the buyers and the providers to develop buyer profiles and provider profiles, said buyer profiles and said provider profiles being stored in a profile database;
developing specifications to provide a request for proposal for an information technology project, said specifications comprising criteria specified by at least one of the buyers;
analyzing said criteria specified by said at least one of the buyers with an intelligent search engine, and matching said criteria to data contained in said provider profiles to identify a group of qualified providers;
developing bidding profiles for each of said qualified providers, wherein said bidding profiles comprise provider specified criteria configured to correspond to said criteria specified by said at least one of the buyers; and
selecting one of said qualified providers by scoring said bidding profiles based on said provider specified criteria, and ranking said bidding profiles using an intelligent selection engine, wherein said ranking of said bidding profiles facilitates the selection of one of said qualified providers to provide said information technology project.

14. A data processing method according to claim 13, wherein said step of registering further comprises:
permitting the buyers and the providers to choose a category of information technology projects and services, and identifying domains of knowledge and technical skills of the buyers and providers.

15. A data processing method according to claim 14, wherein said step of registering further comprises:
assigning a secured workspace within a registration database to facilitate access by the buyers and providers to said data processing system.

16. A data processing method according to claim 13, wherein said step of developing specifications further comprises:
collecting project information based on said criteria specified by said at least one of the buyers, and providing weighting parameters to said criteria specified by said at least one of the buyers.

17. A data processing method according to claim 13, wherein said step of analyzing and matching further comprises:
conducting a technical details match comprising a comparison of domain knowledge specified in said step of developing specifications and domain knowledge captured in said step of registering and stored within said provider profile.

18. A data processing method according to claim 17, wherein said step of analyzing and matching further comprises:
conducting a project management skills match comprising a comparison of project management criteria specified in said step of developing specifications and project management experience information captured in said step of registering and stored within said provider profile.

19. A data processing method according to claim 18, wherein said step of analyzing and matching further comprises:
conducting a project complexity, quality verification and a company structure match comprising a comparison of project complexity, quality verification and company structure criteria specified in said step of developing specifications and project complexity, quality verification and a company structure information captured in said step of registering and stored within said provider profile.

20. A data processing method according to claim 13, wherein said step of selecting further comprises:
conducting a technical details match comprising a comparison of domain knowledge criteria specified in said step of developing specifications and weighted by the buyer and domain knowledge information captured in said step of developing bidding profiles and stored within said bidding profile, said selection module being further configured to provide a score associated with said bidding profile depending on the comparison with said weighted criteria specified in said computerized request for proposal module.

21. A data processing method according to claim 20, wherein said step of selecting further comprises:
conducting a project management skills match comprising a comparison of project management criteria specified in said step of developing specifications and weighted by the buyer and project management information captured in said step of developing bidding profiles and stored within said bidding profile, said selection module being further configured to provide a score associated with said project management information in said bidding profile depending on the comparison with said weighted criteria specified in said computerized request for proposal module.

22. A data processing method according to claim 21, wherein said step of selecting further comprises:
conducting a relevant project experience, estimated project effort, and associated costs match comprising a comparison of project management criteria specified in said step of developing specifications and weighted by the buyer and relevant project experience, estimated project effort, and associated cost information captured in said step of developing bidding profiles and stored within said bidding profile, said selection module being further configured to provide a score associated with said relevant project experience, estimated project effort, and associated cost information in said bidding profile depending on the comparison with said weighted criteria specified in said computerized request for proposal module.

23. A data processing method according to claim 13, wherein said data processing method further comprises a project administration method configured for facilitating the delivering and managing of the information technology projects and services, said project administration method comprising the computer-implemented steps of:
compiling a table of project milestones to be performed by said one of said qualified providers, said project milestones module provided through a computerized interface to permit identification of project tasks by said at least one of the buyers and said one of said qualified providers;
tracking performance criteria associated with performance of said project tasks using a computerized performance metrics module; and
updating status of said project tasks and said performance criteria on a periodic basis using a computerized updating module.

24. A data processing method according to claim 23, said project administration method further comprises the computer-implemented steps of:
providing a payment to said one of said qualified providers using a computerized milestone payment module when said project tasks are completed and verified by said at least one of the buyers.

25. A system configured for facilitating the outsourcing of information technology projects and services between buyers and providers, said system comprising:
a registration module configured for capturing information of the buyers and the providers, said registration module being further configured to develop provider profiles;
a request for proposal module configured for developing specifications for an information technology project, said specifications comprising criteria specified by at least one of the buyers;
a matching module configured for matching said criteria specified by said at least one of the buyers to data contained in said provider profiles to identify a group of qualified providers;
a bidding module configured for providing a bidding profile completed by said qualified providers, said bidding profile comprising provider specified criteria configured to correspond to said criteria specified by said at least one of the buyers in said request for proposal module; and
a selection module configured to score said bidding profiles based on said provider specified criteria, and configured to provide a ranking of said bidding profiles, wherein said ranking of bidding profiles facilitates the selection of one of said qualified providers to provide said information technology project.

26. A system according to claim 25, wherein said registration module is further configured for permitting the buyers and the providers to choose a category of information technology projects and services, is further configured for identifying domains of knowledge and technical skills of the buyers and providers, and is further configured for assigning a secured workspace within a registration database to facilitate access by the buyers and providers to said data processing system.

27. A system according to claim 25, wherein said request for proposal module is further configured for collecting project information based on said criteria specified by said at least one of the buyers, and is further configured for providing weighted parameters to said criteria specified by said at least one of the buyers.

28. A system according to claim 25, wherein said matching module is further configured to conduct one of a technical details match, a project management skills match, a project complexity match, a quality verification match and a company structure match comprising a comparison between one of domain knowledge, project management, project complexity, quality verification and company structure criteria specified by said request for proposal module and between one of domain knowledge, project management experience information, project complexity, quality verification and company structure information captured in said registration module and stored within said provider profile.

29. A system according to claim 25, wherein said selection module is further configured for conducting one of a technical details match and a project management skills match comprising a comparison between one of domain knowledge criteria and project management criteria specified in said request for proposal module and weighted by the buyer and between one of domain knowledge information and project management information captured in said bidding module and stored within said bidding profile, said selection module being further configured to provide a score associated with said bidding profile depending on the comparison with said weighted criteria specified in said request for proposal module.

30. A system according to claim 25, wherein said system further comprises a project administration system configured for facilitating the delivering and managing of the information technology projects and services, said project administration system comprising:
a project milestones module comprising project tasks to be performed by said one of said qualified providers, said project milestones module configured to permit the identification of project tasks by said at least one of the buyers and said one of said qualified providers;
a performance metrics module configured for tracking performance criteria associated with performance of said project tasks; and
an update module configured for updating status of said project tasks and said performance criteria on a periodic basis.

31. A system according to claim 30, wherein said project administration system further comprises:
a milestone payment module configured to provide a payment to said one of said qualified providers when said project tasks are completed by said one of said qualified providers and verified by said at least one of the buyers.

32. A method for facilitating the outsourcing of information technology projects and services between buyers and providers, said method comprising the steps of:
registering the buyers and providers by capturing information of the buyers and the providers to develop buyer profiles and provider profiles, said buyer profiles and said provider profiles being stored in a profile database;
providing a request for proposal for an information technology project, said request for proposal comprising criteria specified by at least one of the buyers;
matching said criteria to data contained in said provider profiles to identify a group of qualified providers;
developing bidding profiles for each of said qualified providers, wherein said bidding profiles comprise provider specified criteria configured to correspond to said criteria specified by said at least one of the buyers; and
ranking said bidding profiles based on said provider specified criteria, wherein said ranking of said bidding profiles facilitates the selection of one of said qualified providers to provide said information technology project.

33. A method according to claim 32, wherein said step of registering further comprises:
permitting the buyers and the providers to choose a category of information technology projects and services;
identifying domains of knowledge and technical skills of the buyers and providers; and
assigning a secured workspace within a registration database to facilitate access by the buyers and providers to said system.

34. A method according to claim 32, wherein said step of developing a request for proposal further comprises:
collecting project information based on said criteria specified by said at least one of the buyers, and providing weighting parameters to said criteria specified by said at least one of the buyers.

35. A method according to claim 32, wherein said step of matching further comprises:
conducting a technical details match comprising a comparison of domain knowledge specified in said step of developing specifications and domain knowledge captured in said step of registering and stored within said provider profile;
conducting a project management skills match comprising a comparison of project management criteria specified in said step of developing specifications and project management experience information captured in said step of registering and stored within said provider profile; and
conducting a project complexity, quality verification and a company structure match comprising a comparison between project complexity, quality verification and company structure criteria specified in said step of developing specifications and between a project complexity, a quality verification and a company structure information captured in said step of registering and stored within said provider profile.

36. A method according to claim 32, wherein said step of selecting further comprises:
conducting a technical details match comprising a comparison of domain knowledge criteria specified in said step of developing specifications and weighted by the buyer and domain knowledge information captured in said step of developing bidding profiles and stored within said bidding profile;
conducting a project management skills match comprising a comparison of project management criteria specified in said step of developing specifications and weighted by the buyer and project management information captured in said step of developing bidding profiles and stored within said bidding profile; and
conducting relevant project experience, estimated project effort, and associated costs matches comprising a comparison of project experience, effort and costs criteria specified in said step of developing specifications and weighted by the buyer and relevant project experience, estimated project effort, and associated cost information captured in said step of developing bidding profiles and stored within said bidding profile, wherein said selection module being further configured to provide a score associated with said bidding profile depending on the comparison with said weighted criteria specified in said request for proposal module.

37. A method according to claim 32, wherein said method further comprises a project administration method configured for facilitating the delivering and managing of the information technology projects and services, said project administration method comprising the steps of:
compiling project milestones to be performed by said one of said qualified providers, said project milestones configured to permit identification of project tasks by said at least one of the buyers and said one of said qualified providers;
tracking performance criteria associated with performance of said project tasks; and
updating status of said project tasks and said performance criteria on a periodic basis.

38. A method according to claim 37, said project administration method further comprising the steps of:
providing a payment to said one of said qualified providers when said project tasks are completed and verified by said at least one of the buyers.
